(19) United States
(12) Patent Application Publication
(10) Pub. No.: US 2012/0212879 A1
(43) Pub. Date: Aug. 23, 2012

(54) HIGH ENERGY HYBRID SUPERCAPACITORS USING LITHIUM METAL POWDERS

(76) Inventors: Linghong Li, Davis, CA (US); Guohua Yang, Woodland, CA (US)

(21) Appl. No.: 13/401,848

(22) Filed: Feb. 22, 2012

Related U.S. Application Data
(60) Provisional application No. 61/463,753, filed on Feb. 23, 2011.

(51) Int. Cl. H01G 9/155

(52) U.S. Cl. 361/502

(57) ABSTRACT

A hybrid supercapacitor comprises a negative electrode made of lithium-absorbing material, a positive electrode with high surface area carbon, and a separator inserted in between containing nonaqueous solvent solution of lithium salt as an electrolyte, wherein air-stable lithium metal powder is coated or added to the above negative electrode. The hybrid supercapacitor of the present invention shows a high capacity, high power, long durability, and is easy to manufacture.

### 1. CROSS REFERENCE TO RELATED APPLICATIONS

This application claims the benefit of U.S. Provisional Patent Application Ser. No. 61/463,753 filed on Feb. 23, 2011.

### 2. TECHNICAL FIELD

The present invention relates to rechargeable hybrid electrical energy storage systems, commonly known as supercapacitors. More particularly, the present invention relates to a lithium ion capacitor having high energy density, high power density and a long cycle life.

### 3. BACKGROUND OF THE INVENTION

Electric double layer capacitors (EDLCs), also known as supercapacitors, or ultracapacitors, have attractive characteristics such as high power densities, fast charge/discharge rates, low equivalent series resistance (ESR), good low temperature performance, and long charge-discharge cycle life. Supercapacitors are considered to be promising energy storage devices, however, their energy density of about 5 watt hours/kg (Wh/kg) is much lower than that of a lithium ion battery, which results in a higher cost per available energy.

Modern electrical device applications require a high energy density (Wh/kg) as well as a high power density (W/kg) (available power per device weight=W/kg). Hence, attention has been paid to a hybrid supercapacitor, comprising a non-polarized Li insertion-type battery material for negative electrodes with a polarized activated carbon for positive electrodes, showing higher energy density than EDLCs, and higher power density than pure rechargeable battery systems. However, due to the large inevitable irreversible capacity of Li insertion-type negative electrode, such a hybrid supercapacitor suffers severe capacity fade.

To overcome the capacity fade, a lithium ion capacitor has also been proposed in U.S. Pat. No. 7,697,269 and thereafter, in which the preliminary charging, or lithium pre-doping of the negative electrode is applied to compensate for the irreversible capacity. However, a lithium auxiliary electrode must be placed in the cell and the preliminary charging of the negative electrode through penetrating pores of both positive and negative electrodes must be carried out during a production process.

Such a hybrid capacitor shows high performance, such as an increased working voltage window and a greatly increased energy density. However, it also has the following drawbacks: (1) the doping of lithium requires a very long time; (2) it tends to be difficult to dope the entire negative electrode uniformly; (3) the doping is practically impossible for a large-size large capacity cell such as a wound cylindrical cell; and (4) a strict manufacturing environment and process is needed to handle lithium metal foils and porous current collectors, thus increasing manufacturing cost.

### SUMMARY OF THE INVENTION

The object of the present invention is to provide a hybrid supercapacitor having a high capacity, high power, long durability, and easy to manufacture.

To achieve the above objects, a hybrid supercapacitor is proposed, comprising a negative electrode made of lithium-absorbing material, a positive electrode with high surface area activated carbons, and a separator inserted in between containing non-aqueous solvent solution of lithium salt as an electrolyte, wherein air-stable lithium metal powder is coated on the surface of the above negative electrode, or mixed with the negative electrode material. The present invention provides the following:
(1) A hybrid supercapacitor comprising negative and positive electrodes with a separator inserted in between containing a nonaqueous solvent solution of lithium salts as an electrolyte.
(2) The positive active material is a material capable of reversibly absorbing lithium ions and/or anions.
(3) The negative electrode is made of lithium-absorbing material, wherein air-stable is lithium metal powder is coated on the negative electrode. The addition of the air-stable lithium metal powder eliminates the long and non-uniform lithium pre-doping process and ensures the simple manufacturing process of large hybrid cells.
(4) The separator inserted between the negative and positive electrodes may comprise any of the previously employed high-porosity, microporous, or absorptive film layers or membranes.
(5) The nonaqueous solvent is a mixture of a cyclic carbonate with a chain carbonate.
(6) The Lithium salt is selected from the group consisting of LiPF₆, LiBF₄, LiAsF₆, LiClO₄, LiN(CF₃SO₂)₂, and LiCF₃SO₃.

By adding an air-stable lithium metal powder in the negative electrode of the present invention, it was found that the energy density and capacity can be greatly improved while maintaining the characteristics of electric double layer capacitors. Such improvements are due to the elimination of the large irreversible capacity of Li insertion-type negative electrode. As a result, the hybrid supercapacitors of the present invention provide a high energy density, a high power density, a large capacity and a long cycle life.

### BRIEF DESCRIPTION OF THE DRAWING

FIG. 1 is a cross-section view of a hybrid supercapacitor of the present invention;

FIG. 2 is a schematic view of coating process of air-stable lithium metal powder on the surface of a negative electrode.

### DETAILED DESCRIPTION OF THE INVENTION

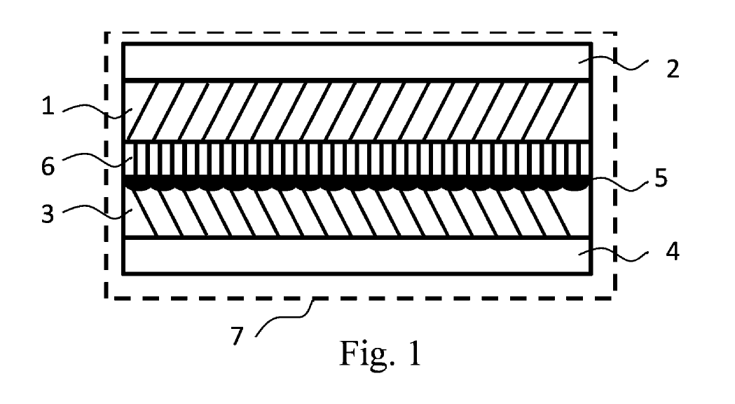

Referring now to the invention in more detail, a hybrid supercapacitor cell of the present invention is shown in FIG. 1, comprising a positive electrode layer 1 on a current collector 2, preferably in the form of aluminum foil, a negative electrode layer 3 on a current collector 4, preferably in the form of copper foil, and a separator 6 inserted in between containing non-aqueous solvent solution of lithium salt as an electrolyte, wherein air-stable lithium metal powder 5 is coated on the surface of the above negative electrode. The whole cell assembly is placed inside a cell container 7, such as a pouch cell with laminated plastic bags or a button cell assembly.

The positive electrode layer in the present invention comprises a positive-active material capable of reversibly adsorbing lithium ions and anions such as tetrafluorophosphate and tetrafluoroborate of the dissolved electrolyte at a high charge/discharge rate. The positive-active material may be selected from carbonaceous carbon, such as activated carbon. The activated carbon can be in the form of powder, foam, or fiber. The activated carbon generally has a 50% volume cumulative diameter (also called D50) of at least 2 μm, preferably from 2 to 20 μm. The positive electrode layer in the present invention is formed from a slurry containing a positive-active material, a binder and an electrically conductive agent, dispersed in an aqueous or organic solvent, and the slurry is applied on a current collector, dried and pressed. The binder may be styrene-butadiene rubber (SBR), carboxymethyl cellulose, polytetrafluoroethylene, polyvinylidene fluoride, or acrylic resin. The amount of the binder varies from 2 to 20 wt %, preferably from 5 to 10 wt %, based on the total weight of the positive electrode layer. Further, the electrically conductive agent may, for example, be acetylene black, carbon black, or graphite. The amount of the electrically conductive agent varies from 0 to 40 wt %, preferably from 5 to 20 wt %, based on the total weight of the positive electrode layer.

The negative electrode layer in the present invention comprises an active material capable of reversibly adsorbing/desorbing lithium ions. The negative active material may be selected from carbonaceous carbon, such as graphite, hard carbon or coke, or soft carbon. Any of the numerous other active negative materials routinely employed in rechargeable Li-ion batteries can be used for the negative electrode of the present system. The negative electrode layer in the present invention is formed from the slurry containing a negative-active material as described above, a binder and an electrically conductive agent if necessary, dispersed in an aqueous or organic solvent, and the slurry is applied on a current collector and dried. The binder can be styrene-butadiene rubber (SBR), carboxymethyl cellulose, polytetrafluoroethylene, polyvinylidene fluoride, and/or acrylic resin. The amount of the binder varies from 2 to 20 wt %, preferably from 5 to 10 wt %, based on the total weight of the positive electrode layer. Further, the electrically conductive agent may, for example, be acetylene black, carbon black, or graphite. The amount of the electrically conductive agent varies from 2 to 40 wt %, preferably from 5 to 20 wt %, based on the total weight of the positive electrode layer.

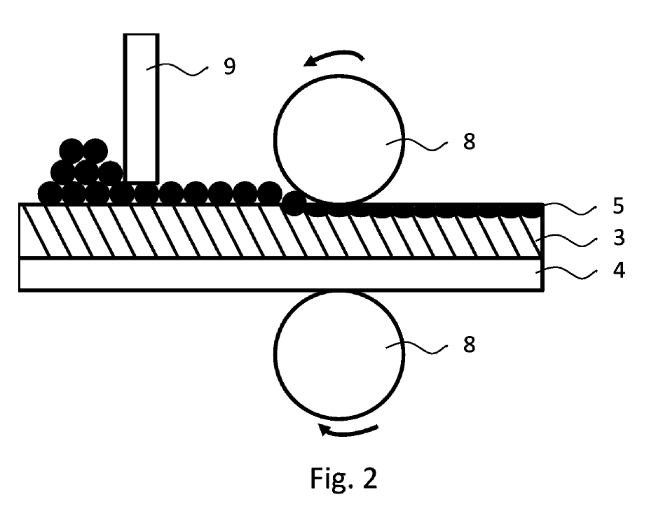

The negative electrode layer in the present invention prepared from the above is further coated with an air-stable lithium metal powder, such as commercially available Stabilized Lithium Metal Powder (SLMP®), with the size of 1-100 μm, preferably from 5 to 50 μm. Referring now to FIG. 2, the dried negative electrode 3 on a current collector 4 is coated with a layer of an air-stable lithium metal powder using blade 9 based on the doctor blade method. The coating can be done in the dry room, which greatly simplify the manufacturing process and reduce the manufacturing cost. The coated negative electrode can then be roll-pressed, preferably by hot press with the Roller 8. The thickness and mass of the lithium metal powder will depend on the amount of the negative active materials.

The negative electrode layer in the present invention can also be formed from the slurry containing a negative-active material, a binder and an electrically conductive agent if necessary, mixed with a specific amount of the air-stable lithium metal powder dispersed in an organic solvent, such as Xylene, and GBL. The slurry is applied on a current collector and dried. The coated negative electrode can then be roll-pressed. The thickness and mass of the lithium metal powder will depend on the amount of the negative active materials.

The separator inserted between the positive electrode and negative electrode comprises a polymeric membrane of, for example, an ultra-high molecular weight micro-fibril polyolefin, a hyper-porous copolymeric membrane, or other type of inert electron-insulating, ion-transmissive polymeric membrane capable of absorbing electrolyte solution, such as glass microfibers.

Upon completion of assembly of the hybrid cell, an electrolyte solution may be introduced in the cell and applied for a time sufficient to allow its absorption into the porous structure of the separator and both electrode layers within the cell. The non-aqueous solvent to form the electrolyte solution in the present invention may be selected from a cyclic carbonate, or a chain carbonate, preferably a mixture of a cyclic carbonate with a chain carbonate. For example, a preferred combination may be ethylene carbonate (EC), propylene carbonate (PC), dimethyl carbonate (DMC), diethyl carbonate (DEC), or ethyl methyl carbonate (EMC) and so on. The electrolyte to be dissolved in the above non-aqueous solvent and mixture to form an electrolyte solution may be selected from a group of compounds capable of forming lithium ions, such as the group consisting of LiPF₆, LiBF₄, LiAsF₆, LiClO₄, and LiCF₃SO₃, and mixture thereof. LiPF₆ is preferred, which is highly ionic. The concentration of the electrolyte in the electrolytic solution is preferably at least 0.5 M, preferably from 1 to 2 M.

### EXAMPLES

The present invention will be explained in more details as shown in the following examples.

### Example 1

### Fabrication of Positive Electrodes

The positive electrode was made of YEC-8B activated carbon (AC) with a specific surface area of 2000 m²/g. Acetylene black with an average grain size of 40 nm and a specific surface area of 40 m²/g was used as the conducting agent. Further, a solution where polyvinylidene fluoride was previously dissolved by 5 wt % in N-methyl pyrrolidone (NMP) was used as the binder. Then, the AC active material, the conductive agent and the polyvinylidene fluoride binder were grinded and mixed at a weight ratio of 80:10:10 as the coating slurry. The slurry was coated on one surface of a current collector comprising an aluminum foil of 20 μm in thickness and dried on a hot plate at 120° C. The dried electrode was hot pressed by a roller.

The electrode was cut out into a square shape with 20 mm width to form a is positive electrode. The total weight of the positive electrode was controlled to about 6 mg/cm².

### Fabrication of Negative Electrodes

The negative electrode was made of a commercial available graphitic carbon with an average grain size of 10 μm. Acetylene black with an average grain size of 40 nm and a specific surface area of 40 m²/g was used as the conducting agent. Further, a solution where polyvinylidene fluoride was previously dissolved by 5 wt % in NMP was used as the binder. Then, the graphitic carbon active material, the conductive agent and the polyvinylidene fluoride binder solution were grinded and mixed at a weight ratio of 85:10:5 as the coating slurry. The slurry was coated on one surface of a current collector comprising a copper foil of 10 μm in thickness and dried on a hot plate at 120° C. The total weight of the positive electrode was controlled to about 6 mg/cm².

The dried negative electrode in the present invention prepared from the above is further coated with an air-stable lithium metal powder, such as commercially available Stabilized Lithium Metal Powder (SLMP®) according to FIG. 2. The amount of lithium powders (SLMP®) is adjusted to 210 mAh/g, with respect to the mount of active graphitic carbon in the negative electrode. The coated negative electrode can then be roll-pressed by hot roller press.

The electrode was cut out into a square shape with 20 mm width to form a negative electrode. The total weight of the negative electrode was controlled to about 6 mg/cm².

### Fabrication of the Hybrid Cell

To complete the fabrication of a hybrid supercapacitor cell of the present invention, the respective positive and negative electrodes prepared above are arranged with an interposed polymeric separator shown in FIG. 1, and the polymeric separator comprises a porous polyethylene separator of 25 μm thick. The assembly is placed in a laminated pouch where an electrolyte solution comprising 1.0 M LiPF₆ of ethylene carbonate, diethyl carbonate, and dimethyl carbonate (volume ratio of 1:1:1) was added and then the assembly was sealed with a plastic sealer for the charge/discharge cycle testing.

### Characteristic Evaluation of Hybrid Supercapacitors

The thus fabricated cell was charged with a constant current at a 10 C rate (C-rate 10 C= 1/10 hour=6 min) until the cell voltage reached 4.0 V under the control of automated test equipment. Then, it was discharged at a constant current at a different C rate of 10 to 100 until the cell voltage reached 2.0 V. The cell capacity of the hybrid cells of the present invention were measured, which is shown as energy densities based on the loading mass of active materials of both electrodes (unit: Wh/kg) at 10 C rate of charging/discharging test. Meanwhile, the rate capability of the hybrid cells was measured as retention ratio of the high C rate discharging capacity to the 10 C rate discharging capacity. Furthermore, cycle stability is reported as percentage capacity decay rate of the initial capacity after 2000 cycles at 10 C rate of charging/discharging cycling test. The test results are summarized in Table 1.

### Example 2, and 3

In Examples 2 to 3, the amount of lithium powders (SLMP®) is adjusted to 280 and 350 mAh/g with respect to the mount of active graphitic carbon in the negative electrode, respectively. The remaining conditions were similar to those in Example 1.

### Example 4

In Example 4, the active material of the negative electrode was changed to a commercially available hard carbon. The amount of lithium powders (SLMP®) is adjusted to 350 mAh/g with respect to the mount of active graphitic carbon in the negative electrode, respectively. The remaining conditions were similar to those in Example 1.

TABLE 1

| | Energy | Rate Capability (%) | | | | Cycle |
|---|---|---|---|---|---|---|
| | Density (Wh/kg) | 10 C | 20 C | 50 C | 100 C | Fade (%) |
| Example 1 | 61 | 100 | 95.6 | 83.0 | 72.4 | <5 |
| Example 2 | 76 | 100 | 96.2 | 84.6 | 75.4 | <5 |
| Example 3 | 103 | 100 | 96.7 | 88.6 | 76.2 | <4 |
| Example 4 | 72 | 100 | 96.2 | 84.6 | 75.4 | <5 |

The results given in Table 1 show high energy densities and high rate capabilities when lithium metal powder was in the negative electrode of the present invention. The cycle test of the hybrid cells of the present invention has exceptional cycle stability, demonstrating that hybrid supercapacitors can achieve similar cycle life versus electric double layer capacitors.

Finally, although the description above contains much specificity, this should not be construed as limiting the scope of the invention, but as merely providing illustrations of some of the presently preferred embodiments of this invention. This invention may be altered and rearranged in numerous ways by one skilled in the art without departing from is the coverage of any patent claims, which are supported by this specification.

The invention claimed is:

1. A hybrid supercapacitor comprising a positive electrode, a negative electrode, a separator inserted between said positive and negative electrode, and a nonaqueous solvent of lithium salts as an electrolytic solution, wherein a positive electrode active material is a material with an active material capable of reversibly absorbing/desorbing lithium ions and/or anions, a negative electrode active material is a material capable of reversibly intercalating lithium ions, and said negative electrode active material containing lithium metal powder.

2. The hybrid supercapacitor according to claim 1, wherein lithium metal powder is coated on the surface of said negative electrode.

3. The hybrid supercapacitor according to claim 1, wherein lithium metal powder is added to active material of said negative electrode.

4. The hybrid supercapacitor according to claim 1, wherein the positive electrode active material is an activated carbon.

5. The hybrid supercapacitor according to claim 1, wherein the negative electrode active material is any one of (a) graphititc carbon, (b) hard carbon, and (c) soft carbon.

6. The hybrid supercapacitor according to claim 1, wherein the capacity per unit weight of the negative electrode active material is larger than the capacity per unit weight of the positive electrode active material.
